(19) United States
(12) Patent Application Publication
(10) Pub. No.: US 2007/0149680 A1
(43) Pub. Date: Jun. 28, 2007

(54) Halogen free polymer and automotive wire using thereof

(76) Inventors: Oh Young Kim, Gyeonggi-do (KR); Hwa Joon Lim, Gyeonggi-do (KR)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/578,944

(22) PCT Filed: Feb. 27, 2004
(86) PCT No.: PCT/KR04/00420

§ 371 Date: May 8, 2006

(30) Foreign Application Priority Data
Nov. 12, 2003 (KR) 10-2003-0079862

(51) Int. Cl. C08K 3/22; C04B 26/06

(52) U.S. Cl. 524/436; 524/437

(57) ABSTRACT

The present invention discloses an insulation composition for halogen-free automotive cables, which comprises a matrix resin, 50-200 parts by weight, based on 100 parts by weight of the matrix resin, of a metal hydroxide flame retardant, and 0.5-20 parts by weight of an antioxidant, in which the matrix resin consists of 1-80 parts by weight of a polyethylene resin, 1-80 parts by weight of an ethylene copolymer resin, and 1-20 parts of a terpolymer of polyethylene, acrylic ester and maleic anhydride. The inventive composition and automotive cables including the same show a reduction generation of poisonous gas and smoke and are eco-friendly. In addition, they are excellent in physical properties, such as flame retardancy, abrasion resistance, scratch resistance, harness, and thermal resistance, and can be extruded at high speed.

### TECHNICAL FIELD

The present invention relates to a halogen-free insulation composition for automotive cables, and automotive cables including the same.

### BACKGROUND ART

Automotive cables are placed in a limited space within automobiles and exposed to environment such as vibration and oil. Thus, unlike general electric wires, the automotive cables require properties, such as flame retardancy, abrasion resistance, scratch resistance, harness, thermal resistance, processibility and lightweightness.

Automotive cables are divided into various temperature grades according to environment and locations, and for a thermal life of 3,000 hours, they are broadly divided into 85° C., 100° C., 125° C., 150° C. and higher grades.

In the prior art, as an insulation material for the 85° C. and 100° C. grade cables, polyvinyl chloride resin has been frequently used. This polyvinyl chloride resin has advantages in that it is inexpensive, and excellent in flame retardancy, processibility and harness.

Meanwhile, the 125° C. grade automotive cables are used as battery cables or for high-temperature wiring, and the 150° C. or higher-grade automotive cables are used in engine parts requiring high thermal resistance.

In the prior art, as an insulation material for the 125° C., 150° C. and higher grade cables, a material obtained by crosslinking ethylene copolymer, such as ethylene vinyl acetate, ethylene ethyl acetate, ethylene methyl acrylate or ethylene butyl acrylate, or polyethylene, such as linear low-density polyethylene (LLDPE), low-density polyethylene (LDPE), medium-density polyethylene (MDPE), high-density polyethylene (HDPE) or chlorinated polyethylene, or a mixture thereof, was used.

As a flame retardant to impart flame retardancy to the resin, a halogen flame retardant such as a bromine flame retardant or a chlorine flame retardant, or a metal hydroxide flame retardant such as aluminum trihydroxide or calcium carbonate, was used. To further increase flame retardancy, a flame retardant aid was also used along with the flame retardant.

However, if the polyvinyl chloride resin is used as the insulation material, there will be a problem in that, upon burning, poisonous gas containing dioxine and hydrogen chloride is generated. If the ethylene copolymer or polyethylene resin is used, abrasion resistance, scratch resistance and high-speed extrusion required in automotive cables cannot be satisfied when a flame retardant is used. In addition, in this case, a remarkable deterioration in physical properties, such as flame retardancy, thermal resistance and harness, will be caused.

Also, if the halogen flame retardant is used as a flame retardant, poisonous gas and excessive smoke will be generated. Also, the use of the metal hydroxide flame retardant will cause a reduction in flame retardancy as compared to the use of the halogen flame retardant. Also, if the metal hydroxide flame retardant is excessively used in order to secure sufficient flame retardancy, there will be a problem in that a serious reduction in processibility and physical properties is caused.

### DISCLOSURE OF INVENTION

Accordingly, the present invention has been made to solve the above-described problems occurring in the prior art, and it is an object of the present invention to provide an insulation composition for automotive cables, which shows a reduced generation of poisonous gas and smoke, is excellent in flame retardancy, abrasion resistance, scratch resistance and thermal resistance, and can be extruded at high speed, as well as automotive cables including the same.

To achieve the above object, in one aspect, the present invention provides an insulation composition for halogen-free automotive cables, which comprises a matrix resin, 50-200 parts by weight, based on 100 parts by weight of the matrix resin, of a metal hydroxide flame retardant, and 0.5-20 parts by weight of an antioxidant, in which the matrix resin consists of 1-80 parts by weight of a polyethylene resin, 1-80 parts by weight of an ethylene copolymer resin, and 1-20 parts of a terpolymer of polyethylene, acrylic ester and maleic anhydride.

In the insulation resin according to the present invention, the polyethylene resin is preferably at least one selected from the group consisting of linear low-density polyethylene (LLDPE), low-density polyethylene (LDPE), medium-density polyethylene (MDPE) and high-density polyethylene (HDPE).

In the inventive composition, the ethylene copolymer resin is preferably at least one selected from the group consisting of ethylene vinyl acetate, ethylene ethyl acrylate, ethylene methyl acrylate, ethylene butyl acrylate, and ethylene octene copolymers.

In the inventive composition, the terpolymer of polyethylene, acrylic ester and maleic anhydride is preferably a terpolymer consisting of 1-80 parts by weight of polyethylene, 1-50 parts by weight of acrylic ester and 1-50 parts by weight of maleic anhydride.

As the metal hydroxide flame retardant in the inventive composition, aluminum trioxide and magnesium dihydroxide may be used alone or in a mixture.

In the inventive composition, the metal hydroxide flame retardant may be used directly or after surface treatment, in which the surface treatment of the metal hydroxide flame retardant is performed with silane, amine, stearic acid or fatty acid.

In the inventive composition, the metal hydroxide flame retardant preferably has a particle size of 0.5-30 μm and a specific surface area (BET) of 3-20 mm²/g.

In the inventive composition, the antioxidant is preferably at least one selected from the group consisting of phenol, hindered phenol, thioester and amine antioxidants.

If the inventive composition is used as an insulation material for 85° C. grade and 100° C. grade electric cables, it will be preferable that the composition should not be crosslinked. If the composition is used as an insulation material for 125° C. and higher-grade electric cables, it will be preferable that the composition should be crosslinked to have a three-dimensional network structure.

In another aspect, the present invention provides automotive cables including an insulation material made of the inventive halogen-free insulation composition for automotive cables.

The inventive halogen-free insulation composition for automotive cables, and automotive cables including the same, show a reduced generation of poisonous gas and smoke, are excellent in physical properties, such as flame retardancy, abrasion resistance, harness and thermal resistance, and can be extruded at high speed.

Accordingly, the inventive composition will be useful for the production of automotive cables.

### BRIEF DESCRIPTION OF DRAWINGS

FIG. I is a cross-sectional view of an electric cable according to one embodiment of the present invention.

### BEST MODE FOR CARRYING OUT THE INVENTION

Hereinafter, the inventive halogen-free insulation composition for automotive cables, and automotive cables including the same, will be described in detail.

By suitably selecting the components of an insulation material for automotive cables, including a matrix resin, a flame retardant and an antioxidant, and their contents, the present invention provides an insulation composition for automotive cables, which shows a reduced generation of poisonous gas and smoke, is excellent in flame retardancy, abrasion resistance, scratch resistance, harness and thermal resistance, and can be extruded at high speed, as well as automotive cables including the same.

The inventive insulation composition for automotive cables comprises a matrix resin, 50-200 parts by weight, based on 100 parts by weight of the matrix resin, of a metal hydroxide flame retardant, and 0.5-20 parts by weight of an antioxidant, in which the matrix resin consists of 1-80 parts by weight of a polyethylene resin, 1-80 parts by weight of an ethylene copolymer, and 1-20 parts by weight of a terpolymer of polyethylene, acrylic ester and maleic anhydride.

As the polyethylene resin in the inventive composition, linear low-density polyethylene (LLDPE), low-density polyethylene (LDPE), medium-density polyethylene (MDPE) and high-density polyethylene (HDPE) may be used alone or in a mixture of two or more.

As the ethylene copolymer resin in the inventive insulation composition, ethylene vinyl acetate, ethylene ethyl acrylate, ethylene methyl acrylate, ethylene butyl acrylate and ethylene octene copolymers may be used alone or in a mixture of two or more.

In the inventive insulation composition, the terpolymer of polyethylene, acrylic ester and maleic anhydride is preferably a terpolymer consisting of 1-80 parts by weight of polyethylene, 1-50 parts by weight of acrylic ester and 1-50 parts by weight of maleic anhydride.

If the polyethylene resin in the inventive composition is used in an amount of less than 1 part by weight or the ethylene copolymer resin is used in an amount of more than 80 parts by weight, a remarkable reduction in abrasion resistance, scratch resistance and harness will be caused. Also, if the polyethylene resin is used in an amount of more than 80 parts by weight or the ethylene copolymer resin is used in an amount of less than 1 part by weight, a remarkable deterioration in physical properties or flame retardancy will be caused.

Also, if the terpolymer of polyethylene, acrylic ester and maleic anhydride is used in an amount of less than 1 part by weight, an improvement in mechanical properties, thermal resistance, oil resistance and particularly abrasion resistance will not be shown, and if the use of the terpolymer in an amount of more than 20 parts by weight will cause deterioration in physical properties, such as flexibility and extrudability.

As the metal hydroxide flame retardant in the inventive composition, aluminum trihydroxide and magnesium dihydroxide may be used alone or in a mixture.

The metal hydroxide flame retardant may be used directly or after surface treatment, in which the surface treatment of the metal hydroxide flame retardant is performed with silane, amine, stearic acid or fatty acid.

The metal hydroxide flame retardant preferably has a particle size of 0.5-30 μm and a specific surface area of 3-20 mm²/g.

The use of the metal hydroxide flame retardant in an amount of less than 50 parts by weight will cause a reduction in flame retardancy, and the use in an amount of more than 200 parts by weight will cause a reduction in mechanical properties and high-speed extrudability as described in Examples below.

Since the metal hydroxide flame retardant has reduced flame retardancy as compared to a halogen flame retardant, it is generally used in excess in order to achieve the desired flame retardant grade. However, the use of an excess of the flame retardant will cause a reduction in processibility, such as extrusion line speed, and physical properties. However, in the present invention, since the matrix resin, the inorganic flame retardant and the antioxidant which have specific components are used at a specific ratio, the problem of deteriorations in flame retardancy and physical properties, which occurs when the prior inorganic flame retardant is used, is solved.

As the antioxidant in the inventive inorganic composition, phenol, hindered phenol, thioester and amine antioxidants may be used alone or in a mixture. In addition, the inventive composition may further comprise a phenolic metal deactivator.

The antioxidant in the inventive composition functions to inhibit the decomposition of an insulation material caused by copper ions which are generated in parts coming in direct contact with a copper conductor.

If the antioxidant is used in an amount of less than 0.5 parts by weight, it will not show the effect of inhibiting the decomposition of the insulation material. If the antioxidant is used in an amount of more than 20 parts by weight, it will have an effect on other properties, such as thermal deformation. Particularly, it will have an effect on crosslinking reaction so that the desired crosslinking will not be performed.

If the phenolic metal deactivator is contained in the composition, it is preferable that the deactivator should be contained in an amount of 0.1-3.0 parts by weight based on 100 parts by weight of the matrix resin. If the phenolic metal deactivator is used in an amount of less than 0.1 part by weight, an inhibitory effect on the decomposition of the insulation material by copper ions will not be increased, and if it is used in an amount of more than 3.0 parts by weight, the deactivation of metal will be increased to reduce the effect of the antioxidant.

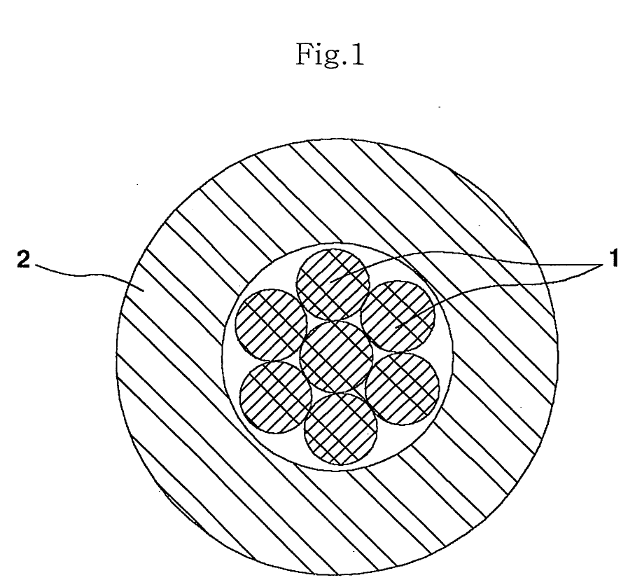

As shown in FIG. 1, the inventive halogen-free insulation material for automotive cables as described above is used as an insulation material covered around conductors 1.

Depending on the end use of electric cables, the inventive halogen-free insulation material for automotive cables is used either in a non-crosslinked state or after crosslinked to have a three-dimensional network structure.

For example, for 85° C. grade or 100° C. grade automotive cables, the inventive insulation material is preferably used in a non-crosslinked state since no process and system for crosslinking is required. On the other hand, for 125° C. or higher-grade automotive cables, the insulation material is preferably used after crosslinked to have a three-dimensional network structure since it must have a higher resistance to high-temperature heat. If the insulation material is used in a non-crosslinked state in 125° C. and higher-grade automotive cables, it will be rapidly damaged by heat emitted from engines, etc.

The crosslinking of the insulation material can be performed by hydroperoxide or irradiation after adding a crosslinking aid to the insulation material.

Hereinafter, the present will be described in further detail by the following examples. It is to be understood, however, that the present invention is not limited to or by the examples, and various changes, variations or modifications to these examples can be made in the scope of the present invention as claimed in the appended claims. The following examples are given to provide a full and complete disclosure of the present invention, and at the same time, to provide a better understanding of the present invention to a person skilled in the art.

Table 1 below shows a formulation according to each of Examples and Comparative Examples.

TABLE 1

| | | | Comp. | Comp. | Comp. | Comp. |
|---|---|---|---|---|---|---|
| Component | Example 1 | Example 2 | Example 1 | Example 2 | Example 3 | Example 4 |
| HDPE | 30 | 50 | — | 80 | 30 | — |
| EVA (VA content: 19%) | 60 | 40 | 100 | — | 70 | 80 |
| Polymer modifier¹ | 10 | 10 | — | 20 | — | 20 |
| Mg(OH) silane coating | 100 | — | 120 | 120 | — | — |
| Al(OH) silane coating | — | 100 | — | — | 40 | 250 |
| Phenolic surfactant² | 2.0 | 2.0 | 2.0 | 0.1 | 2.0 | 0.1 |
| Phenolic metal deactivator³ | 1.0 | 1.0 | 1.0 | 0.1 | 1.0 | — |
| Thioester antioxidant⁴ | 1.0 | 1.0 | 1.0 | 0.1 | 1.0 | 0.1 |
| Crosslinking aid⁵ | 3.0 | 3.0 | 3.0 | 3.0 | 3.0 | 3.0 |

¹Random terpolymer of ethylene, acrylic ester and maleic acid
²Pentaerythritol tetrakis(3-(3,5-di-tert-butyl-4-hydroxyphenyl)propionate
³2,3-bis[[3-[3,5-di-tert-butyl-4-hydroxyphenyl]propionyl]]propionohydrizide
⁴Distearyl ester of β,β′-thiodipropionic acid
⁵Trimethylolpropane trimethacrylate. Crosslinking was performed by irradiation at an irradiation dose of 8 MR.

The sample according to each of Examples and Comparative Examples was measured for abrasion properties according to sandpaper and needle test methods, flame retardant properties, thermal resistance, harness, maximum extrusion speed, tensile strength and elongation.

Concrete Test Methods Are as Follows:

(1) Sandpaper Method

A 150J garnet tape is drawn under an electric wire at a rate of 1500 mm/min while applying a constant load to the electric wire. The length of the tape necessary to strip a coating material of the electric cable to bring the tape into contact with conductors of the electric cable (ISO 6722.5-1).

(2) Needle Test Method

This is to measure the abrasive strength by scratch. A needle with a diameter of 1.14 mm is used to scratch an electric cable so as to perforate an insulation material of the cable. The number of movement cycles of the needle which was moved forward and back until the needle was electrically contacted with conductors of the cable is measured. Similarly to the sandpaper method, a constant load (7N) is applied onto the needle (ISO 6722.5-2).

(3) Flame Retardancy

Flame retardancy is evaluated according to a test method (ISO 6722.12) described in standards for automotive cables. Namely, it is evaluated by the method in which a Bunsen burner is slanted at an angle of about 45° with respect to the ground surface, and the electric cable is in contact with flames at an angle of about 90°.

(4) Thermal Resistance

According to uses described in standards for automotive cables, the sample is heated in an aging oven at 125° C. for 3000 hours and then wound on a mandrel with a diameter of 2-6 mm. Then, the presence or absence of cracks in the cable is determined and a voltage resistance test is carried out (ISO 6722.7).

(5) Harness

After an extruded cable is cut, an insulation material at both ends of the cut cable is removed about 5-10 mm. If the removed face is clearly cut, the sample will be determined to be accepted, and if the removed face is not clearly cut, the sample will be determined to be rejected.

Table 2 below shows the results of the measurements as described above.

TABLE 2

| | | | Comp. | Comp. | Comp. | Comp. |
|---|---|---|---|---|---|---|
| | Example 1 | Example 2 | Example 1 | Example 2 | Example 3 | Example 4 |
| Sandpaper abrasion (300 mm ↑) | 2580 | 3500 | 130 | 2500 | 650 | 800 |
| Needle abrasion (200 cycle ↑) | 650 | 950 | 50 | 500 | 240 | 350 |
| 45° burning test (60 sec ↓) | 5 | 5 | 10 | 4 | 75 | 5 |
| Heat aging (125° C. × 3000 hr) | Accepted | Accepted | Accepted | Rejected | Accepted | Accepted |
| Harness (skin removal) | Accepted | Accepted | Rejected | Accepted | Accepted | Accepted |
| Maximum extrusion speed (500 m/min ↑) | 550 | 500 | 520 | 300 | 750 | 150 |
| Tensile strength (1.50 kg/mm² ↑) | 2.30 | 2.12 | 1.05 | 2.50 | 1.75 | 0.57 |
| Elongation (200% ↑) | 250 | 300 | 700 | 30 | 850 | 30 |

As can be seen in Tables 1 and 2 above, the inventive insulation composition is excellent in physical properties, such as flame retardancy, thermal resistance, harness, tensile strength and elongation, and can be extruded at high speed.

Also, since the inventive composition does not contain a matrix resin and a halogen flame retardant, which cause the generation of poisonous gas upon burning, it shows a reduced generation of poisonous gas and smoke.

On the other hand, the use of ethylene copolymer (ethylene vinyl acetate) alone as the matrix resin (Comparative Example 1), the use of the polyethylene resin and the terpolymer of polyethylene, acrylic ester and maleic anhydride (Comparative Example 2), the use of the ethylene copolymer and the polyethylene resin (Comparative Example 3), the use of the ethylene copolymer and the terpolymer of polyethylene, acrylic ester and maleic anhydride (Comparative Example 4), as the matrix resin, all showed a reduction in flame retardancy, abrasion resistance, harness, thermal resistance, tensile strength or elongation, or could not be extruded at high speed.

Although the preferred embodiments of the present invention have been disclosed, many other modifications and variations can be made without departing from the scope and spirit of the invention. Thus, such modifications and variations will be within the scope of the present invention as disclosed in the accompanying claims.

What is claimed is:

1. An insulation composition for halogen-free automotive cables, which comprises a matrix resin, 50-200 parts by weight, based on 100 parts by weight of the matrix resin, of a metal hydroxide flame retardant, and 0.5-20 parts by weight of an antioxidant, in which the matrix resin consists of 1-80 parts by weight of a polyethylene resin, 1-80 parts by weight of an ethylene copolymer resin, and 1-20 parts of a terpolymer of polyethylene, acrylic ester and maleic anhydride.

2. The insulation composition of claim 1, wherein the polyethylene resin is at least one selected from the group consisting of linear low-density polyethylene, low-density polyethylene, medium-density polyethylene and high-density polyethylene.

3. The insulation material of claim 1, wherein the ethylene copolymer resin is at least one selected from the group consisting of ethylene vinyl acetate, ethylene ethyl acrylate, ethylene methyl acrylate, ethylene butyl acrylate, and ethylene octene copolymers.

4. The insulation material of claim 1, wherein the terpolymer of polyethylene, acrylic ester and maleic anhydride is a terpolymer consisting of 1-80 parts by weight of polyethylene, 1-50 parts by weight of acrylic ester and 1-50 parts by weight of maleic anhydride.

5. The insulation material of claim 1, wherein the metal hydroxide flame retardant is at least one selected from the group consisting of aluminum trioxide and magnesium dihydroxide.

6. The insulation material of claim 5, wherein the metal hydroxide flame retardant is at least one selected from the group consisting of surface-untreated metal hydroxides, and metal hydroxides whose surface had been treated with silane, amine, stearic acid or fatty acid.

7. The insulation material of claim 5, wherein the metal hydroxide flame retardant has a particle size of 0.5-30 μm and a specific surface area (BET) of 3-20 mm²/g.

8. The insulation material of claim 1, wherein the antioxidant is at least one selected from the group consisting of phenol, hindered phenol, thioester and amine antioxidants.

9. The insulation material of claim 8, which further comprises a phenolic metal deactivator.

10. The insulation material of claim 9, wherein the phenolic metal deactivator is used in an amount of 0.1-3.0 parts by weight based on 100 parts by weight of the matrix resin.

11. The insulation material of claim 1, wherein the composition is not crosslinked.

12. The insulation material of claim 1, wherein the composition is crosslinked to have a three-dimensional network structure.

13. Automotive cable comprising an insulation material which is made of a halogen-free insulation composition for automotive cables as set forth in any one of claims 1 to 12.
